(19) United States
(12) Patent Application Publication
(10) Pub. No.: US 2011/0103790 A1
(43) Pub. Date: May 5, 2011

(54) Method and System for Compensating for Optical Impairment in an Optical Signal

(75) Inventors: Paparao Palacharla, Richardson, TX (US); Daniel Bihon, Plano, TX (US)

(73) Assignee: Fujitsu Limited, Kanagawa (JP)

(21) Appl. No.: 12/611,643

(22) Filed: Nov. 3, 2009

(51) Int. Cl. H04J 14/00; H04L 12/26

(52) U.S. Cl. 398/1; 398/58; 370/235

(57) ABSTRACT

Methods and systems are provided for compensating impairment of a signal in an optical network. A method may include: (i) recording, for each node of a plurality nodes of the network, traffic management information specific to such node; (ii) communicating, by each node, its associated traffic management information to one or more other nodes; (iii) receiving, at a particular node of the plurality of nodes, the traffic management information communicated from the one or more nodes; (iv) determining, by the particular node, digital signal processor tap coefficients for a digital coherent receiver integral to the particular node based on at least a portion of the traffic management information; and (v) compensating, by the digital coherent receiver, optical impairment of the optical signal based on at least the determined digital signal processor tap coefficients and processing of the optical signal by a digital signal processor integral to the digital coherent receiver.

### TECHNICAL FIELD OF THE INVENTION

The present invention relates generally to optical networks and, more particularly, to a method and system for compensating fdt optical impairments in an optical signal.

### BACKGROUND

Telecommunications systems, cable television systems and data communication networks use optical networks to rapidly convey large amounts of information between remote points. In an optical network, information is conveyed in the form of optical signals through optical fibers. Optical fibers comprise thin strands of glass capable of communicating the signals over long distances with very low loss. Optical networks often employ wavelength division multiplexing (WDM) or dense wavelength division multiplexing (DWDM) to increase transmission capacity. In WDM and DWDM networks, a number of optical channels are carried in each fiber at disparate wavelengths, thereby increasing network capacity.

An optical signal comprised of disparate wavelengths experiences optical impairments. One type of impairment is optical dispersion, an often undesirable phenomenon that causes the separation of an optical wave into spectral components with different frequencies. Optical dispersion occurs because the differing wavelengths propagate at differing speeds. The separation of an optical wave into its respective channels due to optical dispersion may require optical dispersion compensation for the particular optical signal. Other optical impairments, such as noise, loss, and other linear and nonlinear impairments may also require compensation.

### SUMMARY

In accordance with a particular embodiment of the present invention, a method is provided for impairment compensation of an optical signal communicated in an optical network. The method may include recording, for each node of a plurality nodes of the optical network, traffic management information specific to such node. The method may also include communicating, by each node, its associated traffic management information to one or more other nodes. The method may additionally include receiving, at a particular node of the plurality of nodes, the traffic management information communicated from the one or more nodes. The method may further include determining, by the particular node, digital signal processor tap coefficients for a digital coherent receiver integral to the particular node based on at least a portion of the traffic management information. The method may also include compensating, by the digital coherent receiver, optical impairment of the optical signal based on at least the determined digital signal processor tap coefficients and processing of the optical signal by a digital signal processor integral to the digital coherent receiver.

Technical advantages of one or more embodiments of the present invention may allow for control plane assisted compensation of optical impairment, wherein such compensation provides a “coarse” compensation for optical impairment. This coarse compensation may allow tap coefficients of a digital signal processor integral to a digital coherent receiver receiving the signal to, based on the tap coefficients and the coarse compensation, calculate impairment compensation with greater precision than that of the coarse compensation. The provision of the coarse compensation may effectively limit a tolerance range in which such digital signal processor must converge, thus increasing the speed and reducing the power required for impairment compensation by a digital coherent receiver.

Embodiments of the present invention may also allow for an economically efficient system and method for performing optical impairment compensation on optical signals comprised of channels with different modulation formats. One or more of the embodiments of the present invention may include system components currently in use in optical networks or allow for economically efficient upgrades of or additions to currently used components.

It will be understood that the various embodiments of the present invention may include some, all, or none of the enumerated technical advantages. In addition, other technical advantages of the present invention may be readily apparent to one skilled in the art from the figures, description and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating an example optical network carrying a signal comprising a plurality of sets of channels using at least two different modulation formats;

FIG. 2 illustrates an example digital coherent receiver that may be used with the optical network of FIG. 1; and

FIG. 3 illustrates an example of a method 300 for optical impairment compensation.

### DETAILED DESCRIPTION

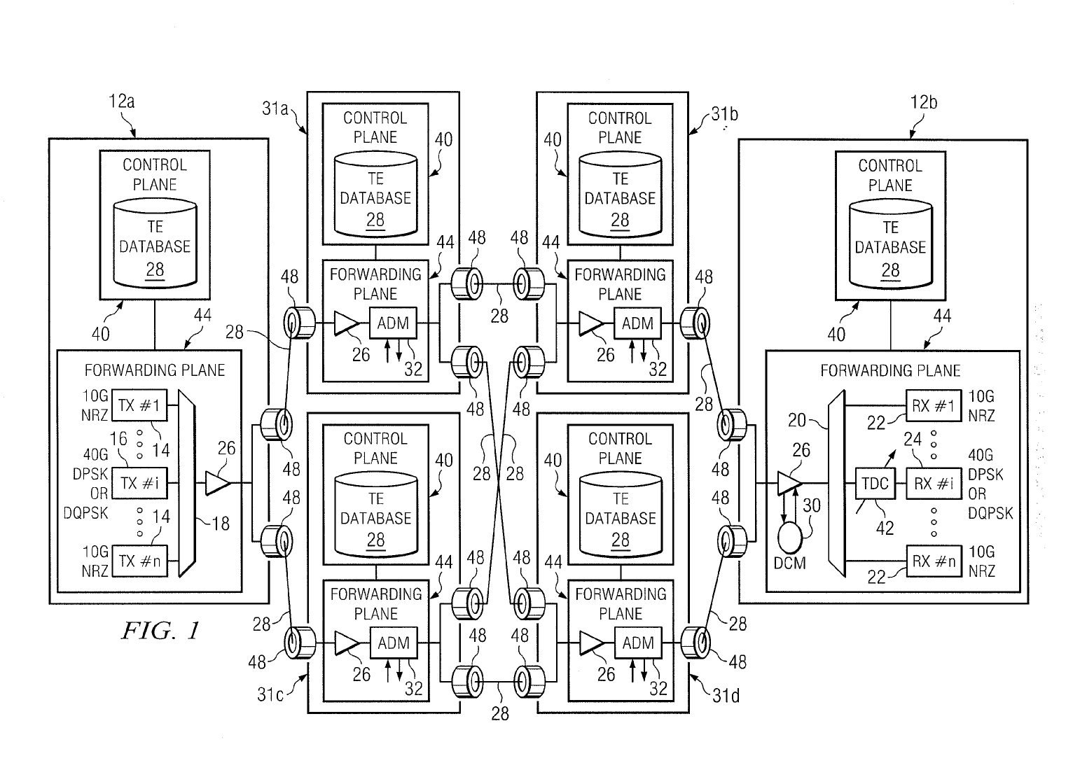

FIG. 1 illustrates an example optical network 10. The optical network 10 includes one or more optical fibers 28 configured to transport one or more optical signals communicated by components of the optical network 10. In some embodiments, optical network 10 may communicate information through signals such as optical signals. An optical signal may have any suitable data rate. Information may include voice, data, audio, video, multimedia, control, signaling, and/or other information. Components of optical network 10, coupled together by the optical fibers 28, may include source node 12a, destination node 12b, and one or more optical add/drop multiplexers (OADM) 31 (for example, OADMs 31a and 31b). Although the optical network 10 is shown as a mesh optical network with source and destination nodes 12, the optical network 10 may also be configured as a ring optical network, a point-to-point optical network, or any other suitable optical network or combination of optical networks. The optical network 10 may be used in a short-haul metropolitan network, a long-haul inter-city network, or any other suitable network or combination of networks.

A node 12 and/or OADM 31 may represent a Label Switching Router (LSR). One or more label switched paths (LSPs) including a sequence of nodes 12 and OADMs 31 may be established for routing packets throughout optical network 10. For example, traffic may travel from source node 12a, through zero, one, or more intermediate OADMs 31, to destination node 12b.

A node 12 and/or OADM 31 may inform other nodes 12 and OADMs 31 (including destination node 12a) of traffic management information associated with the particular node 12 or OADM 31 by communicating messages that include such traffic management information. In certain embodiments, such traffic management information may include information regarding the various elements of optical network 10 that may cause optical impairment (e.g., dispersion, optical loss, lengths of fibers 28, type(s) of fibers 28, etc.). Such traffic management information may be communicated via any suitable message. For example, traffic management information may be recorded in a link-state advertisement (LSA), such as a traffic engineering (TE) link LSA. Traffic management information may be recorded in the LSA any suitable manner. For example, traffic management information may be encoded as a sub-type-link-value (sub-TLV) of a TE link LSA by extending an Interior Gateway Protocol (IGP). Interior Gateway Protocol (IGP) extensions include an Open Shortest Path First-Traffic Engineering (OSPF-TE) extension and an Intermediate System to Intermediate System-Traffic Engineering (ISIS-TE) extension.

A node 12 and/or OADM 31 may include a control plane 40, a forwarding plane 44, and ports 48. Control plane 40 may manage and/or control the routing of messages. For example, control plane 40 for each node 12 and/or OADM 31 may include up a routing table that specifies ports 48 through which traffic for intended for particular destination nodes (e.g., destination node 12b) should be routed. Control plane 40 may include a traffic engineering (TE) database 28 that stores traffic management information related to the various nodes of optical network 10.

Forwarding plane 44 may be communicatively coupled to its associated control plane, and may be configured to forward traffic according to the routing table maintained by control plane 40. Forwarding plane 44 may include one or more components for communicating packets. Such components may include any equipment, system, device, or apparatus utilized to communicate all or part of a packet and/or control the communication of all of part of a packet and may further include, without limitation, fibers, splitters, multiplexers, demultiplexers, wavelength-division multiplexers (WDMs), dense wavelength-division multiplexers (DWDMs), and wavelength selective switches (WSS).

Forwarding plane 44 of source node 12a may include transmitters 14 and 16, a multiplexer 18, and an amplifier 26. Transmitters 14 and 16 include any transmitter or other suitable device configured to transmit optical signals. Each transmitter 14 or 16 may be configured to receive information and to modulate one or more wavelengths of light to encode the information on the wavelength. In optical networking, a wavelength of light may also be referred to as a channel. Each transmitter 14 or 16 may also be configured to transmit this optically encoded information on the associated wavelength. The multiplexer 18 may include any multiplexer or combination of multiplexers or other devices configured to combine different channels into one signal. Multiplexer 18 may be configured to receive and combine the disparate channels transmitted by transmitters 14 and 16 into an optical signal for communication along fibers 28.

Amplifier 26 may be used to amplify the multi-channeled signal. Amplifier 26 may be positioned before and/or after certain lengths of fiber 28. Amplifier 26 may comprise an optical repeater that amplifies the optical signal. This amplification may be performed without opto-electrical or electro-optical conversion. In particular embodiments, amplifier 26 may comprise an optical fiber doped with a rare-earth element. When a signal passes through the fiber, external energy is applied to excite the atoms of the doped portion of the optical fiber, which increases the intensity of the optical signal. As an example, amplifier 26 may comprise an erbium-doped fiber amplifier (EDFA). However, any other suitable amplifier 26 may be used.

The process of communicating information at multiple channels of a single optical signal is referred to in optics as wavelength division multiplexing (WDM). Dense wavelength division multiplexing (DWDM) refers to the multiplexing of a larger (denser) number of wavelengths, usually greater than forty, into a fiber. WDM, DWDM, or other multi-wavelength transmission techniques are employed in optical networks to increase the aggregate bandwidth per optical fiber. Without WDM or DWDM, the bandwidth in networks would be limited to the bit rate of solely one wavelength. With more bandwidth, optical networks are capable of transmitting greater amounts of information. Referring back to FIG. 1, source node 12a in optical network 10 may be configured to transmit and multiplex disparate channels using WDM, DWDM, or some other suitable multi-channel multiplexing technique, and to amplify the multi-channel signal.

As discussed above, the amount of information that can be transmitted over an optical network varies directly with the number of optical channels coded with information and multiplexed into one signal. Therefore, an optical signal employing WDM may carry more information than an optical signal carrying information over solely one channel. An optical signal employing DWDM may carry even more information. Besides the number of channels carried, another factor that affects how much information can be transmitted over an optical network is the bit rate of transmission. The greater the bit rate, the more information may be transmitted.

Improvements and upgrades in optical network capacity generally involve either increasing the number of wavelengths multiplexed into one optical signal or increasing bit rates of information traveling on each wavelength. In either case, it is usually more cost-efficient to use, modify, or add to existing network components than to replace the entire optical system. For reasons relating to the cost of upgrading an optical system, upgrades sometimes occur in stages in which the network must support both new technologies that provide greater bandwidth and old technologies that provide less bandwidth.

Today, many existing networks transmit information at ten gigabits per second (Gb/s) and modulate the optical signal using, for example, a non-return-to-zero (NRZ) modulation technique. Signal transmission upgrades include, for example, transmitting information at forty Gb/s using differential phase shift keying (DPSK) or differential quadrature phase shift keying (DQPSK) to modulate the optical signal. Since upgrading the entire optical network's transmitters would be cost-prohibitive for most optical network operators, many such operators have instead desired to upgrade their networks by incrementally replacing existing ten Gb/s NRZ transmitters with forty Gb/s DPSK or DQPSK transmitters (these types of transmitters being used only as examples).

One challenge faced by those wishing to implement the cost-efficient strategy of integrating upgraded transmitters with existing transmitters is the challenge of optical impairment compensation. Even in existing WDM and DWDM networks, optical signals comprised of disparate wavelengths experience optical impairment, for example, optical dispersion. Optical dispersion refers to the separation of an optical signal into its spectral components with different frequencies. Optical dispersion occurs because the differing wavelengths propagate at differing speeds. As optical signals travel across existing optical networks and experience optical dispersion, they may receive appropriate optical dispersion compensation to achieve at least adequate performance. Specially designed dispersion compensation fibers have been developed to compensate for dispersion in an optical signal comprised of channels modulated using the same modulation technique.

Systems that employ both upgraded transmitters and existing transmitters need to perform optical dispersion compensation on channels that use different modulation techniques. The challenge that arises is that optimal optical dispersion compensation for channels using different modulation techniques may be different. For example, this is in fact the case with channels modulated using NRZ modulation and channels modulated using DPSK, DQPSK or any other suitable phase shift keying modulation technique (referred to generally herein as nPSK).

In the example embodiment in FIG. 1, the WDM signal generated by node 12a may include sets of channels using different modulation formats. In particular, the WDM signal comprises a set of channels communicating information at ten Gb/s using NRZ modulation and a set of channels communicating information at forty Gb/s using nPSK modulation; however, the sets of disparate channels may communicate information at any suitable bit rate and/or using any suitable modulation technique. For example, one or more of the channels may communicate information at a rate of ten, twenty, forty, eighty, over eighty Gb/s, or any other suitable bit rate. One or more of the channels may additionally communicate information using a modulation technique such as return-to-zero (RZ), carrier suppressed return-to-zero (CS-RZ), NRZ, DPSK, DQPSK, or any other suitable modulation technique. As used herein, a “set” of channels may include one or more channels and does not imply any spatial or any other unspecified relationship among the channels (for example, the channels in a set need not be contiguous). In addition, as used herein, “information” may include any information communicated, stored, or sorted in the network. This information may have at least one characteristic modulated to encode audio, video, textual, real-time, non-real-time and/or other suitable data. Additionally, information communicated in optical network 10 may be structured in any appropriate manner including, but not limited to, being structured as frames, packets, or an unstructured bit stream.

After the multi-channel signal is transmitted from source node 12a, the signal may travel over optical fibers 28 to OADMs 31. The optical fibers 28 may include, as appropriate, a single, unidirectional fiber; a single, bi-directional fiber; or a plurality of uni- or bi-directional fibers. Although this description focuses, for the sake of simplicity, on an embodiment of the optical network 10 that supports unidirectional traffic, the present invention further contemplates a bi-directional system that includes appropriately modified embodiments of the components described below to support the transmission of information in opposite directions along the optical network 10. Furthermore, as is discussed in more detail below, the fibers 28 may be high chromatic dispersion fibers (as an example only, standard single mode fiber (SSMF) or non-dispersion shifted fiber (NDSF)), low chromatic dispersion fibers (as an example only, non zero-dispersion-shifted fiber (NZ-DSF), such as E-LEAF fiber), or any other suitable fiber types. According to particular embodiments, different types of fiber 28 create the need for different dispersion compensation schemes to be applied to the signals, as discussed in further detail below.

The individual forwarding planes 44 of OADMs 31 may include an amplifier 26, as well as an add/drop module 32 (ADM). As discussed above, amplifiers 26 may be used to amplify the WDM signal as it travels through the optical network 10. ADMs 32 may include any device or combination of devices configured to add and/or drop optical signals from fibers 28, as are well-known in the art.

After a signal passes through an OADM 31, the signal may travel along fibers 28 directly to destination node 12b, or the signal may be passed through one or more additional OADMs 31 (such as OADM 31b, for example) before reaching destination node 12b (the destination node might also be an OADM, such as in a ring network). Destination node 12b may be configured to receive signals transmitted over optical network 10. Forwarding plane 44 of destination node 12b may include an amplifier 26 and an associated dispersion compensating module (DCM) 30, a demultiplexer 20, and receivers 22 and 24. As described above, amplifier 26 may be used to amplify the WDM signal as it travels through the optical network 10. DCM 30 include any dispersion compensating fiber (DCF), tunable dispersion compensator (TDC), variable dispersion compensator (VDC) or other dispersion compensating device configured to perform optical dispersion compensation on a signal or set of channels comprising a signal using one or more modulation techniques. Although optical network 10 shows DCM 30 coupled to a respective amplifier 26, the DCM 30 may also be positioned separately from amplifier 26.

Demultiplexer 20 may include any demultiplexer or other device configured to separate the disparate channels multiplexed using WDM, DWDM, or other suitable multi-channel multiplexing technique. Demultiplexer 20 may be configured to receive an optical signal carrying a plurality of multiplexed channels, demultiplex the disparate channels in the optical signal, and pass the disparate channels to different receivers 22 and 24.

Receivers 22 and 24 may include any receiver or other suitable device configured to receive an optical signal. Each receiver 22 or 24 may be configured to receive a channel of an optical signal carrying encoded information and demodulate the information into an electrical signal. These channels received by receivers 22 or 24 may include the channels transmitted by transmitters 14 and 16 and/or channels added by ADMs 32. In addition, the forty Gb/s nPSK channels (and/or any other suitable channels) may be additionally compensated at destination node 12b using, for example, tunable dispersion compensators (TDCs) 42 associated with receivers 24.

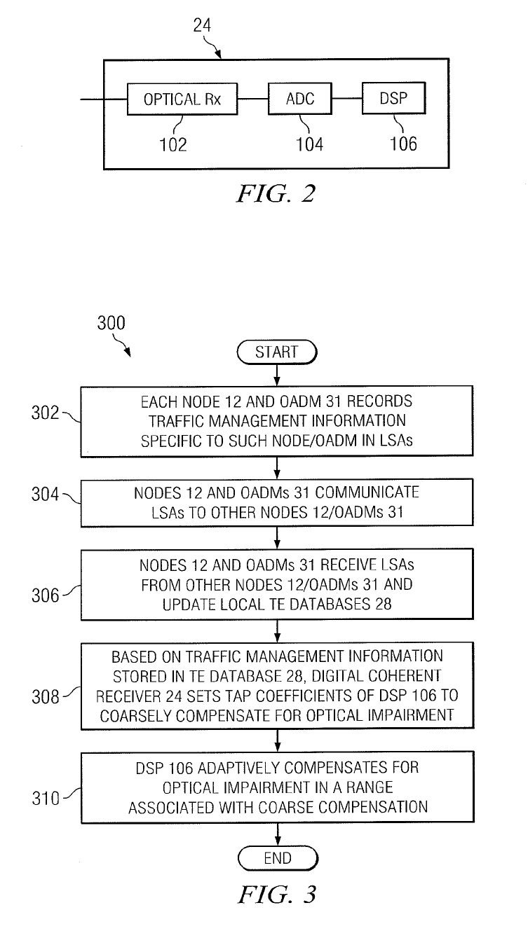

In some embodiments, one or more of receivers 24 may comprise a digital coherent receiver, such as receiver 24 depicted in FIG. 2. Components of receiver 24 may include an optical receiver 102, analog-to-digital converter (ADC) 104, and digital signal processor (DSP) 106. Optical receiver 102 may include any receiver or other suitable device configured to receive an optical signal and convert such optical signal to an analog electrical signal, as is known in the art. ADC 104 may include any suitable system, device or apparatus, include any system, device, or apparatus configured to convert an analog optical signal (e.g., an electrical signal received from optical receiver 102) to a discrete digital number. DSP 106 may include a microprocessor-like circuit configured to processes digital signals using numerous techniques including filtering, transforms, and others. In some embodiments, DSP 106 may be a programmable-tap DSP. In a programmable-tap DSP, processing performed by the DSP may be based in part on various programmable coefficient weights given to particular processing modules or “taps” of the DSP. When used as an integral component of a digital coherent receiver, DSP 106 may be configured to perform equalization, carrier estimation, and/or adaptive compensation of optical impairments. A limitation of traditional DSP-based approaches to optical impairment compensation is that the number of taps needed for compensation of optical impairment may be numerous, and thus lead to significant power usage and design complexity. For example, the number of taps needed for compensation of chromatic dispersion is often proportional to data rate and required tolerance range. In the case of 100 Gb/s paths with 40,000 ps/nm tolerance, the number of taps required may range between 500 and 800.

Returning to FIG. 1, in operation of optical network 10, transmitters 14 and 16 of destination node 12a may transmit information at different bit rates and/or using different modulation techniques over different channels. Multiplexer 18 may combine these different channels into an optical signal and may communicate the signal over optical fiber 28. An amplifier 26 may receive the optical signal, may amplify the signal, and may pass the signal over optical fiber 28. Optical fiber 28 may transport the signal to OADM 31a. Amplifier 26 of OADM 31a may receive the signal, amplify the signal, and pass the signal to ADM 32 of OADM 31a. After receiving the optical signal, ADM 32 may drop channels from the optical signal and/or add channels to the optical signal.

After the signal passes through the one or more OADMs 31 (such as, for example, OADMs 31a and 31b), DCM 30 of destination node 12b may receive the forwarded signal and may perform optical dispersion compensation on the signal. The demultiplexer 20 of destination node 12b may receive the signal, may demultiplex the signal into the signal's constituent channels, and may pass the signal's constituent channels. Each channel may be received by an associated receiver 22 or 24 of destination node 12b and forwarded. In particular embodiments, optical dispersion compensation may be performed on the forty Gb/s nPSK channels at destination node 12b using a TDC 42 or other dispersion compensating device, as described above.

In embodiments of the present disclosure, a destination node (e.g., node 12b), may be configured to analyze or process traffic management information stored in traffic engineering database 28 to determine approximate values of optical impairment (e.g., chromatic dispersion, polarization mode dispersion, optical loss) for one or more channels based on parameters associated with the path of the channel through optical network 10 (e.g., length of fibers 28, type(s) of fibers, etc.). Results of such analysis may be used to assist in the operation of receivers 24, particularly in embodiments of optical network 10 in which receivers 24 comprise digital coherent receivers.

For example, such results may provide a “coarse” compensation for optical impairment which may be communicated to optical coherent receiver 24. Such compensation may be made by statically configuring DSP taps using a database of pre-determined and/or pre-stored values. Such database may be stored within traffic engineering database 28, receiver 24, or another suitable component of destination node 12b. DSP 106 may then be used to provide “fine” compensation, and may require fewer adaptive taps to do so, thus possibly leading to lower DSP convergence time and/or lower power consumption. As a specific example, in embodiments in which optical coherent receiver 24 is used to compensate for chromatic dispersion with a tolerance range of 0-40,000 ps/nm, the database of pre-deteiniined and/or pre-stored values may include coarse tap coefficients ranging from 0-40,000 ps/nm with steps of 100 ps/nm. Based on traffic management information stored in traffic engineering database 28, a particular set of tap coefficients may be selected by receiver 24 and communicated to DSP 106. DSP 106 may then, based on such pre-determined tap coefficients, perform a fine compensation using adaptive taps within the 100 ps/nm range. In addition, nonlinear impairments may be compensated with digital coherent receiver 24 by configuring DSP 106 with backward propagation, such that a received optical signal is processed in the backward direction in order to estimate the signal at the source transmitter.

As noted above, although the optical network 10 is shown as a mesh optical network with source and destination nodes, the optical network 10 may also be configured as a ring optical network, a point-to-point optical network, or any other suitable optical network or combination of optical networks.

A component of optical network 10, may include an interface, logic, memory, and/or other suitable elements. An interface may receive input, send output, process the input and/or output, and/or perform other suitable operations. An interface may comprise hardware and/or software.

Logic may perform the operations of the component, for example, execute instructions to generate output from input. Logic may include hardware, software, and/or other logic, and may be stored in memory. Certain logic, such as a processor, may manage the operation of a component. Examples of a processor include one or more computers, one or more microprocessors, one or more applications, and/or other logic.

A memory may store information. A memory may comprise a computer-readable storage medium, such as computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable storage medium.

Modifications, additions, or omissions may be made to optical network 10 without departing from the scope of the invention. The components of optical network 10 may be integrated or separated. Moreover, the operations of optical network 10 may be performed by more, fewer, or other components. Additionally, operations of optical network 10 may be performed using any suitable logic. As used in this document, “each” may refer to each member of a set or each member of a subset of a set.

In addition, although the terms “node” and “OADM” are used throughout this disclosure to denote components of optical system 10, it is understood that the term “node” may broadly be construed to include, without limitation, an “OADM.”

FIG. 3 illustrates an example of a method 300 for optical impairment compensation. The method may begin at step 302, where each node 12/OADM 31 may record traffic management information specific to such node 12/OADM 31 in link state advertisements. At step 304, nodes 12/OADMs 31 may communicate link state advertisements (including traffic management information) to other nodes 12/OADMs 31. At step 306, the various nodes 12/OADMs 31 may receive the link state advertisements communicated from other nodes 12/OADMs 31 and update their respective traffic engineering databases 28 accordingly.

At step 308, based on traffic management information stored in an associated respective traffic engineering database 28, digital coherent receiver 24 may set one or more tap coefficients of DSP 106, thus coarsely compensating for optical impairment. At step 310, DSP 106 may adaptively compensate for optical impairment in a range associated with the coarse compensation made in step 308.

Modifications, additions, or omissions may be made to the method without departing from the scope of the invention. The method may include more, fewer, or other steps. Additionally, steps may be performed in any suitable order.

Although the present invention has been described with several embodiments, various changes and modifications may be suggested to one skilled in the art. It is intended that the present invention encompass such changes and modifications as fall within the scope of the appended claims.

What is claimed is:

1. A method for impairment compensation of an optical signal communicated in an optical network, the method comprising:
recording, for each node of a plurality nodes of the optical network, traffic management information specific to such node;
communicating, by each node, its associated traffic management information to one or more other nodes;
receiving, at a particular node of the plurality of nodes, the traffic management information communicated from the one or more nodes;
determining, by the particular node, digital signal processor tap coefficients for a digital coherent receiver integral to the particular node based on at least a portion of the traffic management information; and
compensating, by the digital coherent receiver, optical impairment of the optical signal based on at least the determined digital signal processor tap coefficients and processing of the optical signal by a digital signal processor integral to the digital coherent receiver.

2. A method according to claim 1, wherein communicating associated traffic management information includes communicating the associated traffic management information via a link state advertisement.

3. A method according to claim 1, wherein the traffic management information includes one or more parameters of the optical network indicative of optical impairment.

4. A method according to claim 3, wherein the one or more parameters include information indicative of at least one of: (i) a length of one or more fibers integral to the optical network, and (ii) a type of one of more fibers integral to the optical network.

5. A method according to claim 1, wherein the optical impairment includes at least one of chromatic dispersion, polarization mode dispersion, and optical loss.

6. A method according to claim 1, wherein the plurality of nodes includes at least one source node, one destination node, and one optical add-drop multiplexer.

7. A method according to claim 1, wherein determining the digital signal processor tap coefficients includes referencing a database of pre-determined tap coefficients and selecting one or more pre-determined tap coefficients based on at least the portion of the traffic management information.

8. A method according to claim 1, wherein determining the digital signal processor tap coefficients provides the digital signal processor with a coarse approximation of optical impairment.

9. A method according to claim 8, wherein processing by the digital signal processor includes calculating optical impairment based on the coarse approximation and with greater precision than the coarse approximation.

10. A system for impairment compensation of an optical signal communicated in an optical network, the system comprising:
logic embodied in one or more memories and configured to:
record, for each node of a plurality nodes of the optical network, traffic management information specific to such node;
communicate, for each node, its associated traffic management information to one or more other nodes;
receive, at a particular node of the plurality of nodes, the traffic management information communicated from the one or more nodes;
determine digital signal processor tap coefficients for a digital coherent receiver integral to the particular node based on at least a portion of the traffic management information; and
compensate optical impairment of the optical signal based on at least the determined digital signal processor tap coefficients and processing of the optical signal by a digital signal processor integral to the digital coherent receiver.

11. A system according to claim 10, the logic further configured to communicating the associated traffic management information via a link state advertisement.

12. A system according to claim 10, wherein the traffic management information includes one or more parameters of the optical network indicative of optical impairment.

13. A system according to claim 12, wherein the one or more parameters include information indicative of at least one of: (i) a length of one or more fibers integral to the optical network, and (ii) a type of one of more fibers integral to the optical network.

14. A system according to claim 10, wherein the optical impairment includes at least one of chromatic dispersion, polarization mode dispersion, and optical loss.

15. A system according to claim 10, wherein the plurality of nodes includes at least one source node, one destination node, and one optical add-drop multiplexer.

16. A system according to claim 10, the logic further configured to determine the digital signal processor tap coefficients by referencing a database of pre-determined tap coefficients and selecting one or more pre-determined tap coefficients based on at least the portion of the traffic management information.

17. A system according to claim 10, wherein the determination of the digital signal processor tap coefficients provides the digital signal processor with a coarse approximation of optical impairment.

18. A system according to claim 17, wherein processing by the digital signal processor includes calculating optical impairment based on the coarse approximation and with greater precision than the coarse approximation.

19. Logic for impairment compensation of an optical signal communicated in an optical network, the logic embodied in a computer-readable storage medium and when executed by a computer operable to:
record, for each node of a plurality nodes of the optical network, traffic management information specific to such node;
communicate, for each node, its associated traffic management information to one or more other nodes;
receive, at a particular node of the plurality of nodes, the traffic management information communicated from the one or more nodes;
determine digital signal processor tap coefficients for a digital coherent receiver integral to the particular node based on at least a portion of the traffic' management information; and
compensate optical impairment of the optical signal based on at least the determined digital signal processor tap coefficients and processing of the optical signal by a digital signal processor integral to the digital coherent receiver.

20. A system for impairment compensation of an optical signal communicated in an optical network, the system comprising:
means for recording, for each node of a plurality nodes of the optical network, traffic management information specific to such node;
means for communicating, for each node, its associated traffic management information to one or more other nodes;
means for receiving, at a particular node of the plurality of nodes, the traffic management information communicated from the one or more nodes;
means for determining digital signal processor tap coefficients for a digital coherent receiver integral to the particular node based on at least a portion of the traffic management information; and
means for compensating optical impairment of the optical signal based on at least the determined digital signal processor tap coefficients and processing of the optical signal by a digital signal processor integral to the digital coherent receiver.
